(19) United States
(12) Patent Application Publication
(10) Pub. No.: US 2017/0286635 A1
(43) Pub. Date: Oct. 5, 2017

(54) SYSTEM AND METHOD FOR ENABLING AUTOMATED ORDERING OF CUSTOM COMPOUNDED MEDICATIONS

(71) Applicant: Bronson Medical Technologies Inc., Kingsport, TN (US)

(72) Inventor: Robert H. Harshbarger, III, Kingsport, TN (US)

(21) Appl. No.: 15/479,555

(22) Filed: Apr. 5, 2017

Related U.S. Application Data
(60) Provisional application No. 62/318,289, filed on Apr. 5, 2016.

(51) Int. Cl. G06F 19/00

(52) U.S. Cl. CPC G06F 19/3456; G06F 19/326

(57) ABSTRACT

A system for processing prescriptions of customized medications is provided including a memory storing a database of ingredients that may be used in custom compounded medications and drug interactions between the ingredients. The database may include patient information having identification of patients and their prescribed medications. The system further includes a processor configured to: receive a prescription request for a customized medication from a user for a selected patient; retrieve any existing prescribed medications for the selected patient; prompt the user to select ingredients of the customized medication; upon selection of all ingredients of the customized medication, access the database to compare each ingredient of the customized medication to any existing prescribed medications and their ingredients to identify any potential drug interactions; and when any potential drug interactions are identified, create an alert to inform the user of any potential drug interactions resulting from prescribing the customized medication.

### CROSS-REFERENCE TO RELATED APPLICATION

This application claims priority to and the benefit under 35 U.S.C. §119(e) of U.S. Provisional Patent Application No. 62/318,289, filed on Apr. 5, 2016, entitled “SYSTEM AND METHOD FOR ENABLING AUTOMATED ORDERING OF CUSTOM COMPOUNDED MEDICATIONS,” the entire disclosure of which is hereby incorporated herein by reference.

### FIELD OF THE INVENTION

The present invention generally relates to a system and method for enabling automated ordering of custom compounded medications.

### BACKGROUND OF THE INVENTION

Systems are known that allow a prescribing physician to prescribe pre-existing medications electronically, where the system will alert the prescribing physician of any potential drug interactions based upon known interactions with medications the patient is taking and to alert the prescribing physician of any allergies from which the patient suffers that may be triggered by the prescribed medication. These systems do determine drug interactions based upon the names of the medications. Such systems do not exist for custom compounded medications, which do not have pre-existing medication names to compare in a database.

### SUMMARY OF THE INVENTION

According to one aspect of the present invention, a system for processing prescriptions of customized medications is provided comprising a memory storing a database of ingredients that may be used in custom compounded medications and drug interactions between the ingredients, wherein one of the database and an additional database includes patient information including identification of patients and their prescribed medications. The system further comprises a processor configured to interact with the database and further configured to: receive a prescription request for a customized medication from a user for a selected patient; retrieve any existing prescribed medications for the selected patient; in response to the prescription request, prompt the user to select ingredients of the customized medication; upon selection of all ingredients of the customized medication, access the database to compare each ingredient of the customized medication to any existing prescribed medications and their ingredients to identify any potential drug interactions; and when any potential drug interactions are identified, create an alert to inform the user of any potential drug interactions resulting from prescribing the customized medication.

According to another embodiment of the present invention, a system for processing prescriptions of customized medications is provided comprising a prescription server device comprising: a memory storing a database of ingredients that may be used in custom compounded medications and drug interactions between the ingredients, wherein one of the database and an additional database includes patient information including identification of patients and their prescribed medications, and a server processor configured to interact with the database. The system further comprises at least one prescriber device for interacting with the prescription server device over a distributed computer network and configured to generate a prescription request for a customized medication for a selected patient, wherein the server processor is further configured to: receive a prescription request for a customized medication from the at least one prescriber device for a selected patient; retrieve any existing prescribed medications for the selected patient; in response to the prescription request, prompt the at least one prescriber device to provide ingredients of the customized medication; upon selection of all ingredients of the customized medication, access the database to compare each ingredient of the customized medication to any existing prescribed medications and their ingredients to identify any potential drug interactions; and when any potential drug interactions are identified, create an alert to inform the at least one prescriber device of any potential drug interactions resulting from prescribing the customized medication.

According to another embodiment of the present invention, a method of processing prescriptions of customized medications over a computer distributed network is provided where the method comprises: storing in a memory device, a database of ingredients that may be used in custom compounded medications and drug interactions between the ingredients, wherein one of the database and an additional database includes patient information including identification of patients and their prescribed medications; receiving a prescription request for a customized medication from a user for a selected patient; retrieving any existing prescribed medications for the selected patient; prompting the user to select ingredients of the customized medication; upon selection of all ingredients of the customized medication, accessing the database to compare each ingredient of the customized medication to any existing prescribed medications and their ingredients to identify any potential drug interactions; and when any potential drug interactions are identified, creating an alert to inform the user of any potential drug interactions resulting from prescribing the customized medication.

According to another embodiment of the present invention, a non-transitory tangible computer readable medium is provided having stored thereon software instructions that, when executed by a processor in a server, cause the processor to process a prescription request for a custom compounded medication, by executing the steps comprising: storing in a memory device, a database of ingredients that may be used in custom compounded medications and drug interactions between the ingredients, wherein one of the database and an additional database includes patient information including identification of patients and their prescribed medications; receiving a prescription request for a customized medication from a user for a selected patient; retrieving any existing prescribed medications for the selected patient; prompting the user to select ingredients of the customized medication; upon selection of all ingredients of the customized medication, accessing the database to compare each ingredient of the customized medication to any existing prescribed medications and their ingredients to identify any potential drug interactions; and when any potential drug interactions are identified, creating an alert to inform the user of any potential drug interactions resulting from prescribing the customized medication.

According to another embodiment of the present invention, a system for processing prescriptions of customized medications is provided comprising a memory storing a database of ingredients that may be used in custom compounded medications, wherein one of the database and an additional database includes patient information including identification of patients and their prescribed medications. The system further comprises a processor configured to interact with the database and further configured to: receive a prescription request for a customized medication from a user for a selected patient; in response to the prescription request, prompt the user to select a category of the customized medication; after selection of the category, cause to be displayed on a display of the user, medications/ingredients categorized in the selected category; prompt the user to provide ingredients of the customized medication; and upon selection of all ingredients of the customized medication, alert a pharmacist of the prescription request.

According to another embodiment of the present invention, a method of processing prescriptions of customized medications over a computer distributed network is provided where the method comprises: storing in a memory device, a database of ingredients that may be used in custom compounded medications and drug interactions between the ingredients, wherein one of the database and an additional database includes patient information including identification of patients and their prescribed medications; receiving a prescription request for a customized medication from a user for a selected patient; in response to the prescription request, prompting the user to select a category of the customized medication; after selection of the category, causing to be displayed on a display of the user, medications/ingredients categorized in the selected category; prompting the user to provide ingredients of the customized medication; and upon selection of all ingredients of the customized medication, alerting a pharmacist of the prescription request.

According to another embodiment of the present invention, a non-transitory tangible computer readable medium is provided having stored thereon software instructions that, when executed by a processor in a server, cause the processor to process a prescription request for a custom compounded medication, by executing the steps comprising: storing in a memory device, a database of ingredients that may be used in custom compounded medications and drug interactions between the ingredients, wherein one of the database and an additional database includes patient information including identification of patients and their prescribed medications; receiving a prescription request for a customized medication from a user for a selected patient; in response to the prescription request, prompting the user to select a category of the customized medication; after selection of the category, causing to be displayed on a display of the user, medications/ingredients categorized in the selected category; prompting the user to provide ingredients of the customized medication; and upon selection of all ingredients of the customized medication, alerting a pharmacist of the prescription request.

These and other features, advantages, and objects of the present invention will be further understood and appreciated by those skilled in the art by reference to the following specification, claims, and appended drawings.

### BRIEF DESCRIPTION OF THE DRAWINGS

The present invention will become more fully understood from the detailed description and the accompanying drawings, wherein:

FIG. 1 is a block diagram illustrating a system for filling prescriptions;

FIG. 2 is a block diagram illustrating components of a prescription server used in the system shown in FIG. 1;

FIG. 3 is a block diagram illustrating components of a prescribing device used in the system shown in FIG. 1;

FIG. 4 is an example of a screenshot for a patient profile that may be displayed on a prescribing device in the system shown in FIG. 1;

FIG. 5 is a flow chart of a method of operation of the system of FIG. 1;

FIG. 6 is an example of a screenshot for a list of categories that may be displayed on a prescribing device in the system shown in FIG. 1;

FIG. 7 is an example of a screenshot for creating a category that may be displayed on a prescribing device in the system shown in FIG. 1;

FIG. 8 is an example of a screenshot for creating a compound that may be displayed on a prescribing device in the system shown in FIG. 1;

FIG. 9 is an example of a screenshot for creating a custom compound that may be displayed on a prescribing device in the system shown in FIG. 1;

FIG. 10 is an example of a screenshot for a listing of ingredients that may be displayed on a prescribing device in the system shown in FIG. 1;

FIG. 11 is an example of a screenshot for creating an ingredient that may be displayed on a prescribing device in the system shown in FIG. 1;

FIG. 12 is an example of a screenshot for a review of the prescription request that may be displayed on a prescribing device in the system shown in FIG. 1;

FIG. 13 is an example of a screenshot for pending prescriptions that may be displayed on a pharmacy device in the system shown in FIG. 1;

FIG. 14 is a flow diagram showing the steps performed by the prescribing physician and the pharmacy using the system of FIG. 1;

FIG. 15 is an example of a screenshot showing a prompt for the prescribing physician's PIN code;

FIG. 16 is an example of a prescription form as may be faxed or otherwise delivered to a pharmacy using the system of FIG. 1; and

FIG. 17 is an example of a screenshot showing a contraindications notification.

### DETAILED DESCRIPTION OF THE EMBODIMENTS

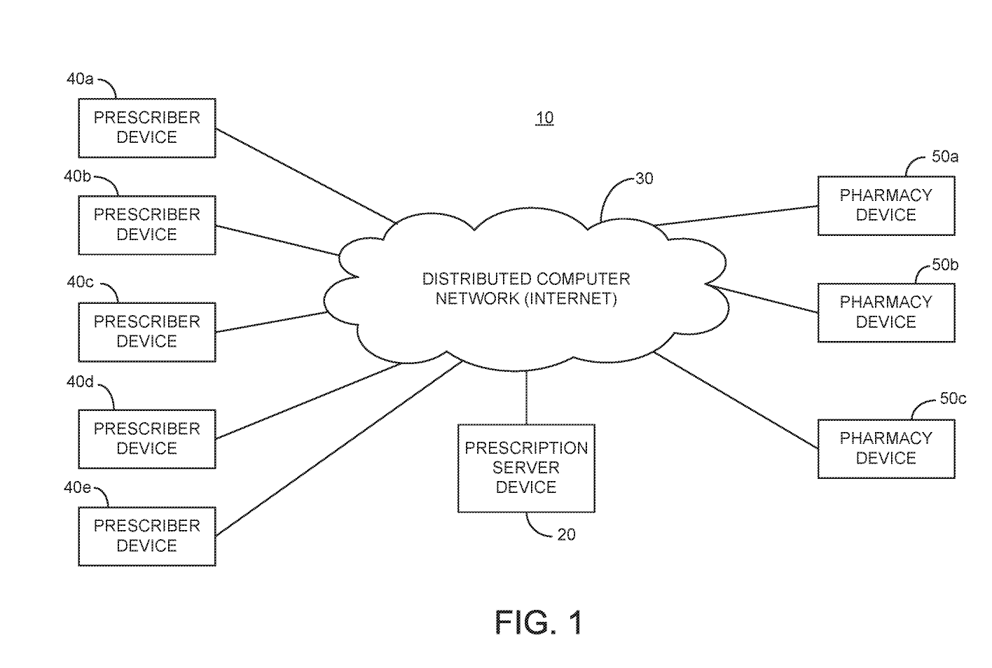

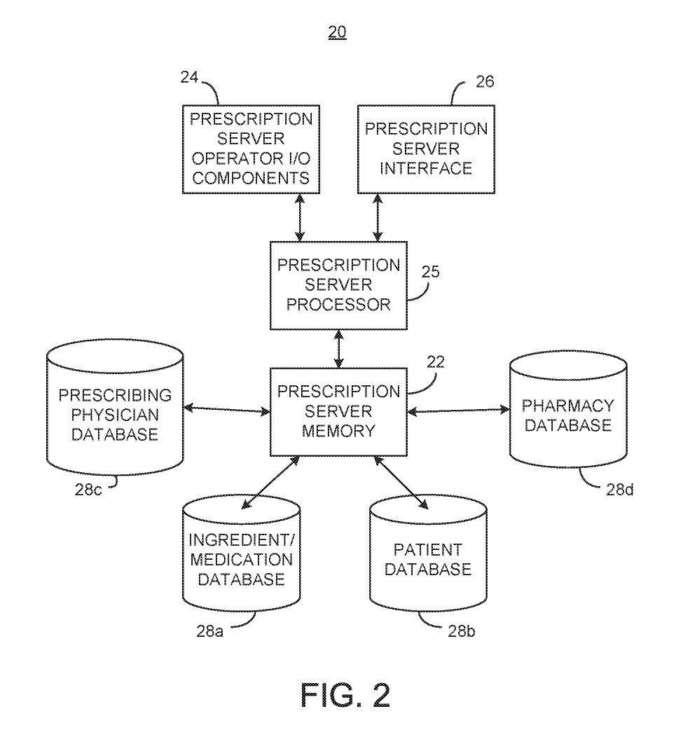

The embodiments described herein pertain to a system and method for receiving/filling prescriptions including custom prescriptions and optionally non-custom prescriptions. FIG. 1 shows an example of such a system 10. As shown, the system 10 includes a prescription server device 20 accessible over a distributed computer network 30, such as the Internet. As shown in FIG. 2, prescription server device 20 includes a prescription server memory 22, prescription server operator I/O components 24, a prescription server interface 26 for coupling to the distributed computer network 30, and a prescription server processor 25, which may be coupled to memory 22, operator I/O components 24, and interface 26. Memory 22 may store a database 28a of ingredients that may be used in custom compounded medications and drug interactions between the ingredients. This database 28a may also include patient information including identification of patients and their prescribed medications. Optionally, a separate patient database 28b may be provided for this purpose. Patient database 28b may be stored in memory 22 or may be stored in other memory accessible by the server through a local network or distributed network 30. Similarly, ingredient/medication database 28a may be stored in other memory accessible by the server through a local network or distributed network 30. Additionally, a prescribing physician database 28c and an optional pharmacy database 28d may be stored in memory 22 or may be stored in other memory accessible by the server through a local network or distributed network 30.

Prescription server processor 25 is configured to interact with at least one of databases 28a, 28b, 28c, and 28d. The prescribing physician database 28c includes a profile for each prescribing physician registered with the web-based prescription service provided using prescription server processor 25. Each profile may include any one or more of the following: the prescribing physician's name, office name, address, phone number, email, security role, username, password, electronic signature, provider, and a personal identification number (PIN). As described below, the PIN is required for the prescription request to be submitted. Also, the system 10 may be configured to only maintain the following prescribing physician's information: name, address, telephone#, fax#, NPI#, DEA#, signature, name of practice site, unique prescribing physician ID#.

The ingredient/medication database 28a may include known ingredients used in medications, known compounds and their ingredients, known drug interactions between ingredients, and categories of compounds as well as lists of compounds in each category along with active ingredients and dosages of ingredients. For the system 10 to perform its basic functions, it only needs to maintain a list of both FDA approved commercially available medications and non-FDA approved bulk chemicals which are then sorted in a variety of custom compounded formulations that are then categorized based on the compounding pharmacist's professional recommendation that is a reflection of the prescribing physician's immediate recommendation and/or past prescribing habits.

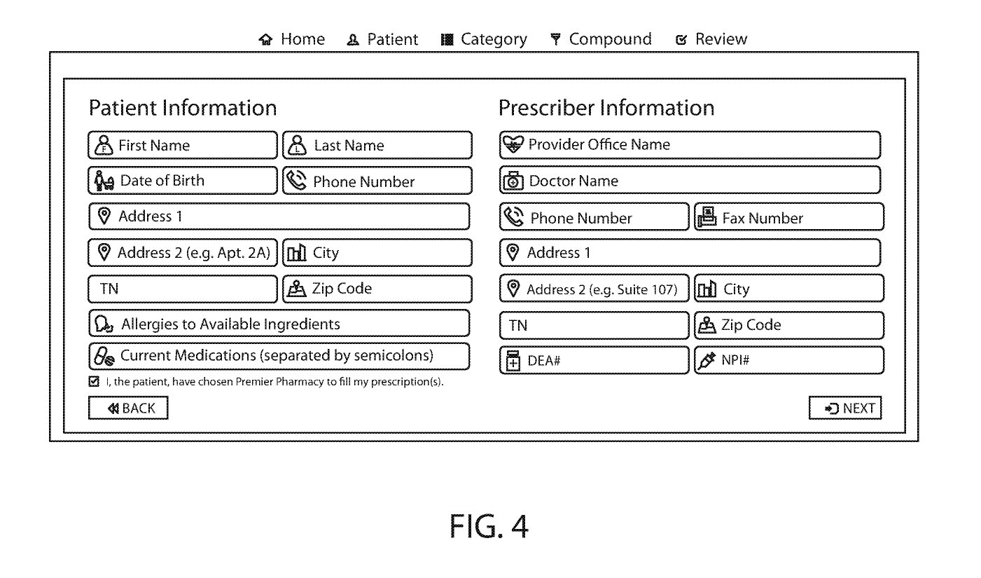

The patient database 28b may include, for each patient, the patient's name, address, phone number, allergies to available ingredients, and current medications. An example of a screen shot of the patient information screen is shown in FIG. 4. Patient database 28b may optionally include a preferred pharmacy as well as their prescribing physician(s). Alternatively, the system 10 may only maintain the basic information found on prescription orders submitted by a prescribing physician for a specific patient—this listing may be prescription-specific not patient-specific (i.e. the prescribing physician may be required to enter the patient's information each time a prescribing is submitted while using the system). By including allergies to available ingredients in patient database 28b, when a new prescription is requested, server processor 25 may compare the ingredients of the newly prescribed medication to those to which the patient is allergic so as to alert the person filling out the prescription request of such allergies. Similarly, by including current medications of the patient, server processor 25 may access ingredient/medication database to determine if there are any contraindications for the ingredients of the newly prescribed medication relative to those ingredients of the current medications (as well as those other ingredients of the newly prescribed medication so as to alert the person filling out the prescription request of such a potential drug interaction).

The optional pharmacy database 28d may include a listing of various pharmacies through which the prescription may be filled. Each such pharmacy may have its own pharmacy device 50a-50c, which may be a personal computer, laptop, notebook, or smartphone, which may communicate with prescription server 20 via distributed computer network 30 or via a local network. It should be noted that prescription server 20 may be hosted by a single pharmacy or single company having various pharmacy locations. In this case, all prescriptions would be filled by that pharmacy or a selected location of the pharmacy. On the other hand, a plurality of independent pharmacies may subscribe to the prescription services offered through prescription server 20.

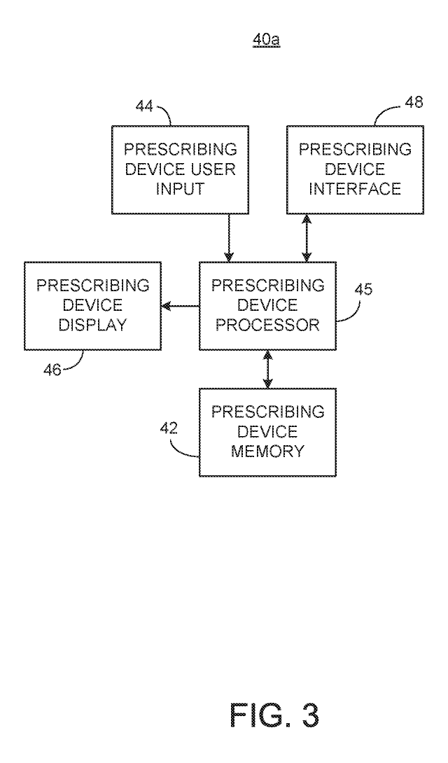

Referring back to FIG. 1, at least one prescriber device 40a-40e, which is configured for interacting with prescription server device 20 over distributed computer network 30, may be further configured to generate a prescription request for a customized medication for a selected patient. FIG. 3 shows an example of the components that may constitute prescriber device 40a. As shown, prescribing device 40a may include a prescribing device memory 42, a prescribing device user input 44, a prescribing device display 46, and a prescribing device interface 48 for coupling to distributed computer network 30. Each of these components of prescribing device 40a may be coupled to a prescribing device processor 45. Prescribing devices 40a-40e may be any form of a personal computer, laptop, notebook, or smartphone. In general, prescriber devices 40a-40e are used by prescribing physicians or their offices for prescribing medications for patients. Conceivably, however, prescriber devices 40a-40e may be used at a pharmacy to enter a prescription received from a prescribing physician or prescribing physician's office by other means. Alternatively, if prescription server 20 is hosted by a pharmacy, prescriptions may be entered directly to the server via operator I/O components 24.

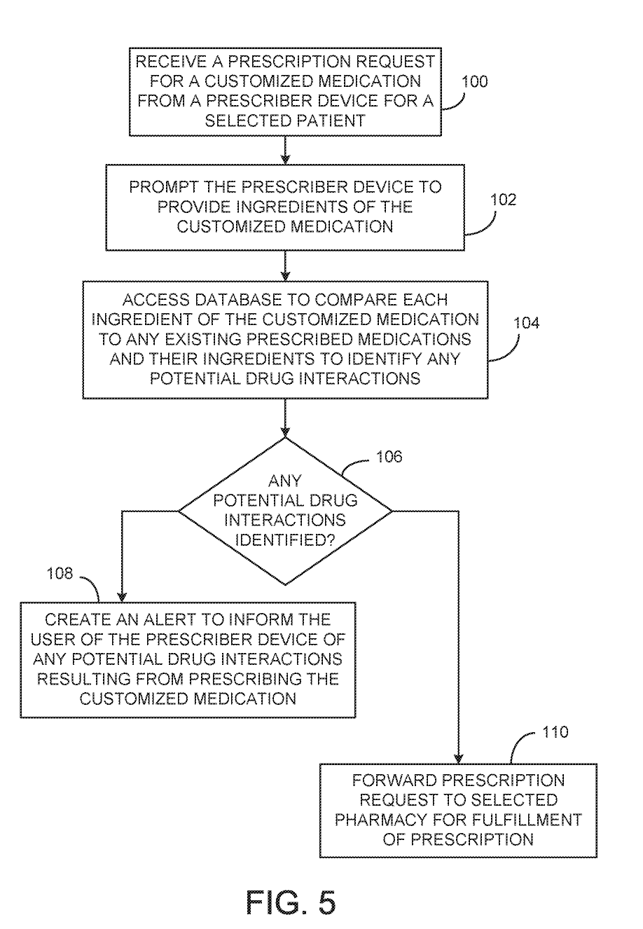

The general method for processing prescriptions for custom compounded medications will now be described with reference to FIG. 5. This method is described below as being implemented by prescription server processor 25 using data retrieved from at least ingredient/medication database 28a and patient database 28b (which may be separate databases or a single database). This method may be a subroutine executed by any processor, and thus this method may be embodied in a non-transitory computer readable medium having stored thereon software instructions that, when executed by a processor, cause the processor to process prescriptions for custom compounded medications, by executing the steps of the method described below. In other words, aspects of the inventive method may be achieved by software stored on a non-transitory tangible computer readable medium or software modifications or updates to existing software residing in a non-transitory computer readable medium.

FIG. 5 shows a flow chart of the steps of the method for processing a prescription request for a customized medication. Details of each step will be described following the overall description of the method. The method begins in step 100 with the prescription server processor 25 configured to receive a prescription request for a customized medication from one of the prescriber devices 40a-40e for a selected patient. Next, in step 102, server processor 25 retrieves any existing prescribed medications for the selected patient from patient database 28b. Then, in step 104, in response to receiving the prescription request, server processor 25 prompts the prescriber device (40a-40e) (and hence also its user) to provide the ingredients of the customized medication. Such a prompt would generally take the form of a display screen that is shown on prescribing device display 46. Upon selection of all ingredients of the customized medication, server processor 25 accesses ingredient/medication database 28a and patient database 28b to compare each ingredient of the customized medication to any existing prescribed medications and their ingredients to identify any potential drug interactions (step 104). Then, in step 106, server processor 25 determines whether any such potential drug interactions have been identified. If a potential drug interaction has been identified, server processor 25 signals prescribing device 40a such that it informs the user of device 40a of the potential drug interaction (step 108). Otherwise, if no drug interactions are identified (and optionally if no allergies are identified), server processor 25 forwards the prescription request to a selected pharmacy (which may be the preferred pharmacy of the patient) (step 110).

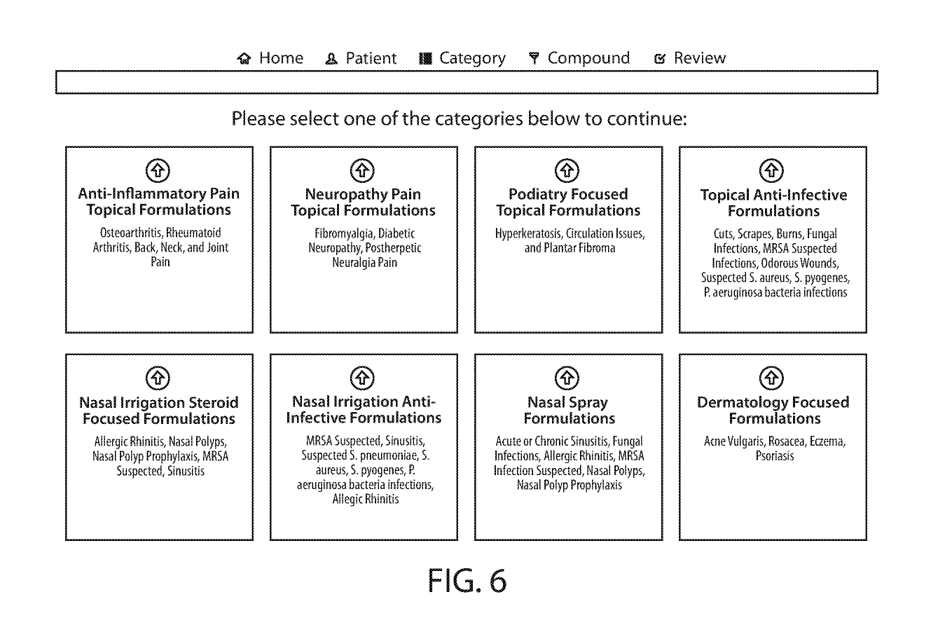

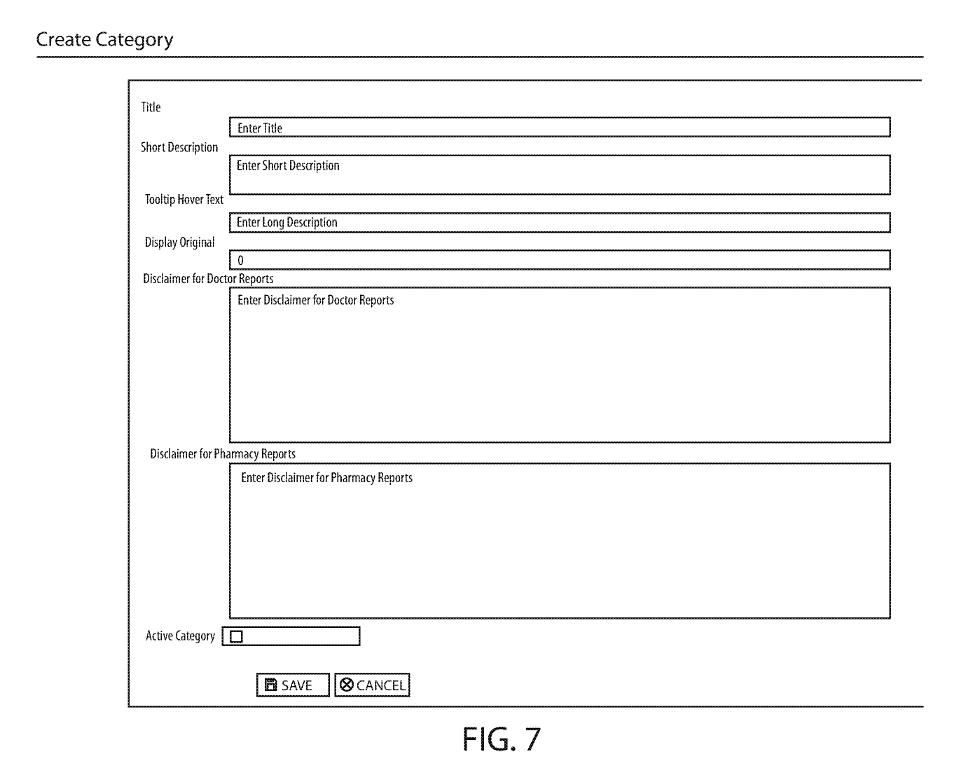

Looking at this method in more detail, when a user accesses a prescribing device 40a-40e to request a prescription, the user is presented with various categories to select. Examples of such categories are shown in the exemplary screenshot in FIG. 6. If an appropriate category does not exist, the user may create a category. An example of a screenshot for creating a category is shown in FIG. 7. To create a category, the user provides a title; a short description; tooltip hover text, which may be a long description that is displayed when a cursor is held over a designated icon associated with the category; a display ordinal (which is a way to order the categories); a disclaimer for prescribing physician reports; a disclaimer for pharmacy reports; and an indication if the category is to be an active category.

Each category may be prepopulated and therefore each formulation is prepopulated based on the compounding pharmacist's professional option. Categories may be created by the compounding pharmacist in collaboration with the prescribing physician or based on past prescribing habits of the physician. Compounded formulation categories may include but are not limited to; topical pain management, topical anti-infective treatment options, nasal irrigation treatment options, topical scar treatment options, hormone replacement therapy etc. However, the physician may elect to create his/her own personal formulation by entering detailed information in the “other” field found at the bottom of each category (i.e. drug name, drug strength, quantity and route of administration). The drugs available for further customization by the physician are available from a predetermined list created by the compounding pharmacist. This list may include anywhere from 10 medications up to 1,000,000 different medications, for example, it all depends on how many medications the compounding pharmacist enters into the system.

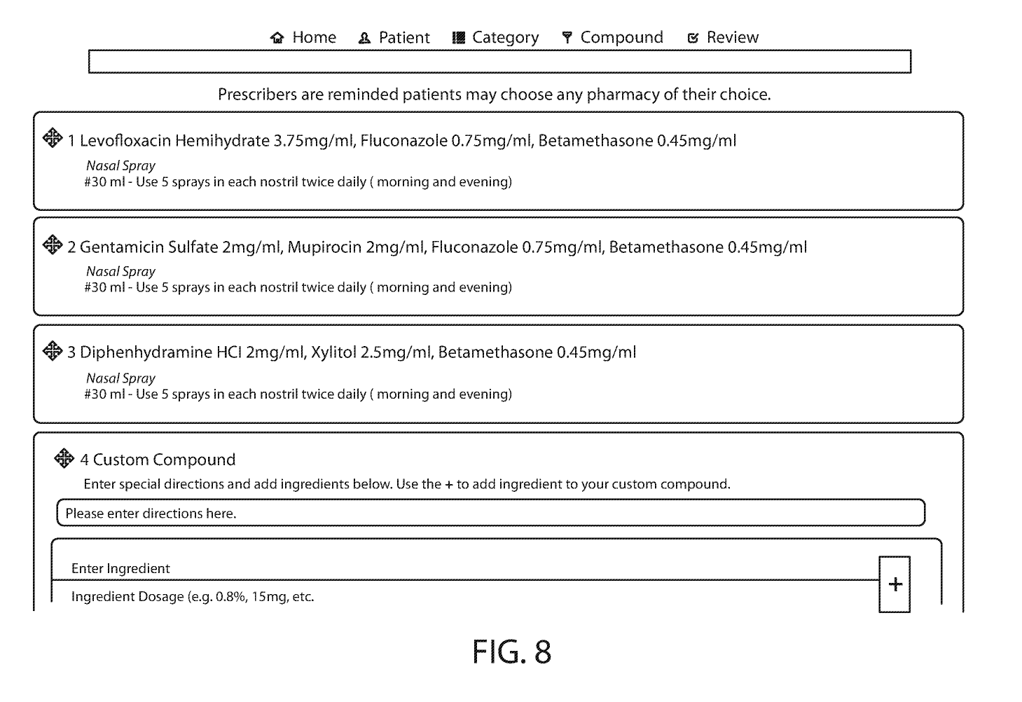

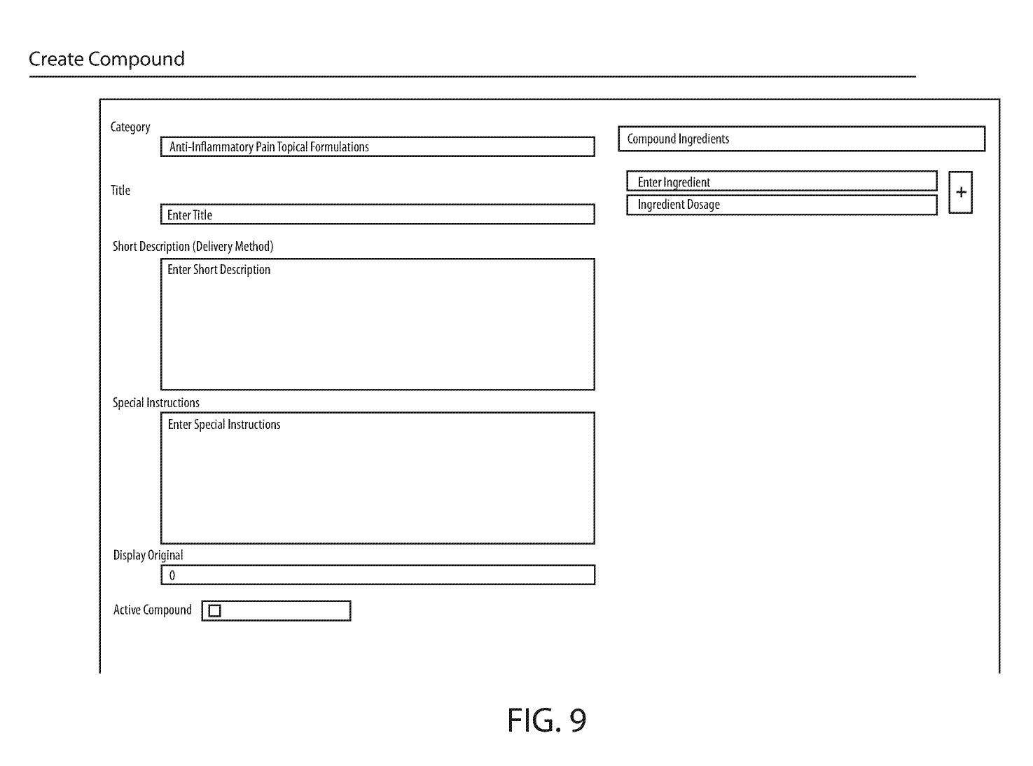

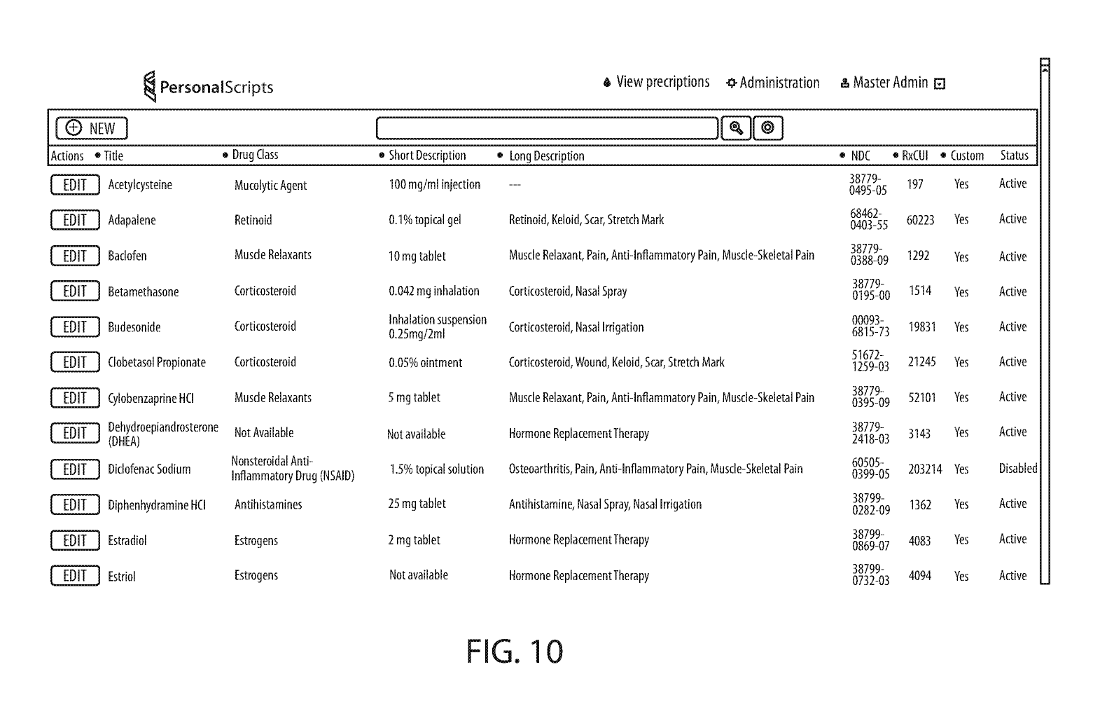

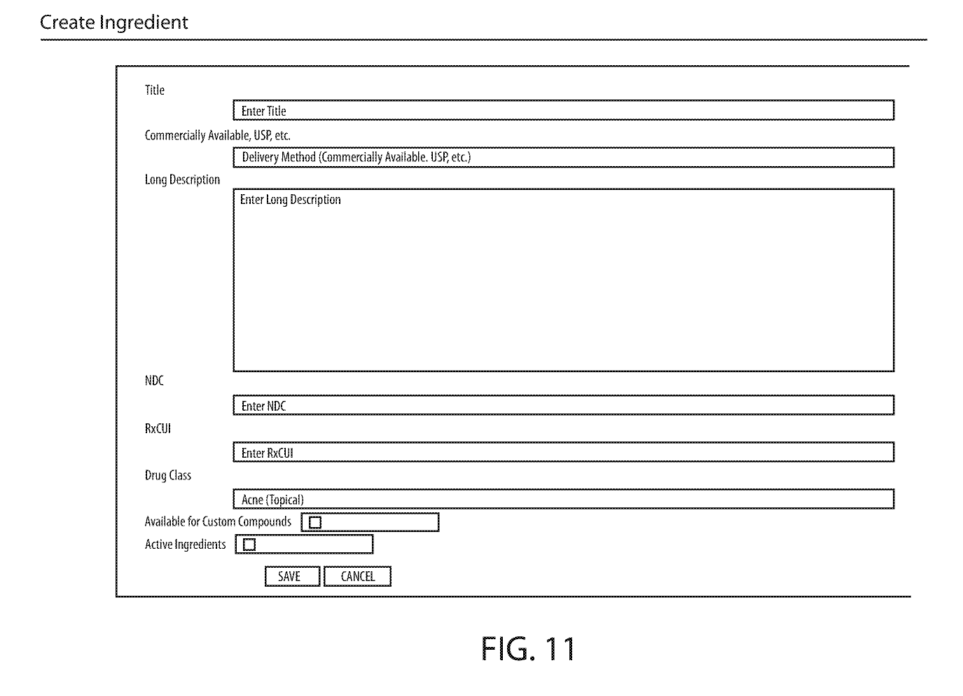

Upon selection of a category, the user is presented with the prepopulated listing of compounds associated with that particular category along with an option to create a new custom compound. An example of such a display screenshot is shown in FIG. 8. To create a new compound, the user provides any special directions for use of the compound and adds ingredients and their dosages (in weight, volume, or percentages), as well as a title, the category, a short description of the delivery method, special instructions, a display ordinal, and an indication if the compound is to be an active compound. An example of such a display screenshot is shown in FIG. 9. In adding ingredients, the user may select from pre-existing ingredients (upon viewing a display such as the screenshot shown in FIG. 10) or may create a new ingredient. For each created ingredient, the user provides a title, the delivery method (whether the ingredient is commercially available, USP, etc.), a long description, the NDC, RxCUI, and drug class, an indication whether the ingredient is available for custom compounds, and an indication if the ingredient is to be considered an active ingredient. An example of such a display screenshot is shown in FIG. 11.

Compounds are created from individual medications that have unique National Drug Codes (NDC) assigned to them by their specific drug manufacturer. Medications may be further categorized into commercially available or bulk chemicals. Commercially available medications are those drugs that are approved by the Federal Drug Administration (FDA) for a specific disease state at a specific strength and specific route of administration. Bulk chemicals contain FDA approved active pharmaceutical ingredients; however, they are not approved by the FDA because they are raw chemicals and are not approved for a specific disease state at a specific strength and specific route of administration. The above described system and method would allow a physician to prescribe both commercially available medications alone or in conjunction with bulk chemicals and present corresponding contraindications if applicable. Current Electronic Medical Record (EMR) programs only alert physicians when there are potential contraindications between two or more commercially available medications. RxCUI is a unique identifier for a drug assigned by the National Library of Medicine. Drug to drug interactions, contraindications and allergies are determined by the information presented by each individual patient based on their past medical history and the corresponding compounded formulation selected. The description of each contraindication may be sourced by the National Library of Medicine databank using the NDC, RxCUI, and the drug class of each ingredient.

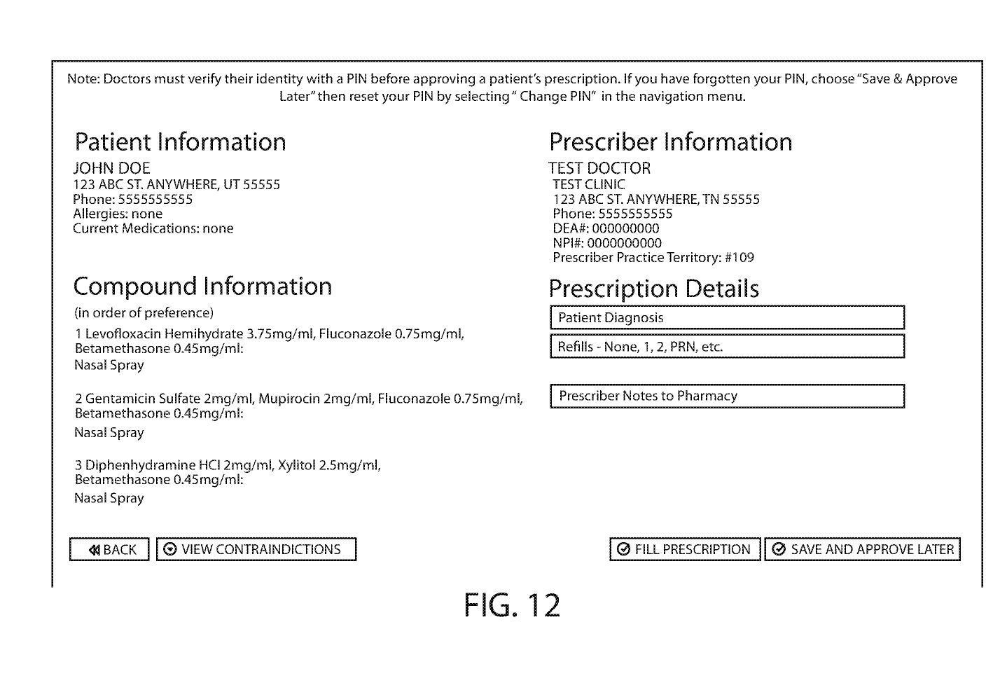

After the ingredients for the custom compound are created, a review screen such as that shown in FIG. 12 is displayed to the user. The user may then select to perform a contraindication check or submit the prescription request. If the contraindication check is skipped by the prescribing physician, it can still be performed by the pharmacist before filling the prescription.

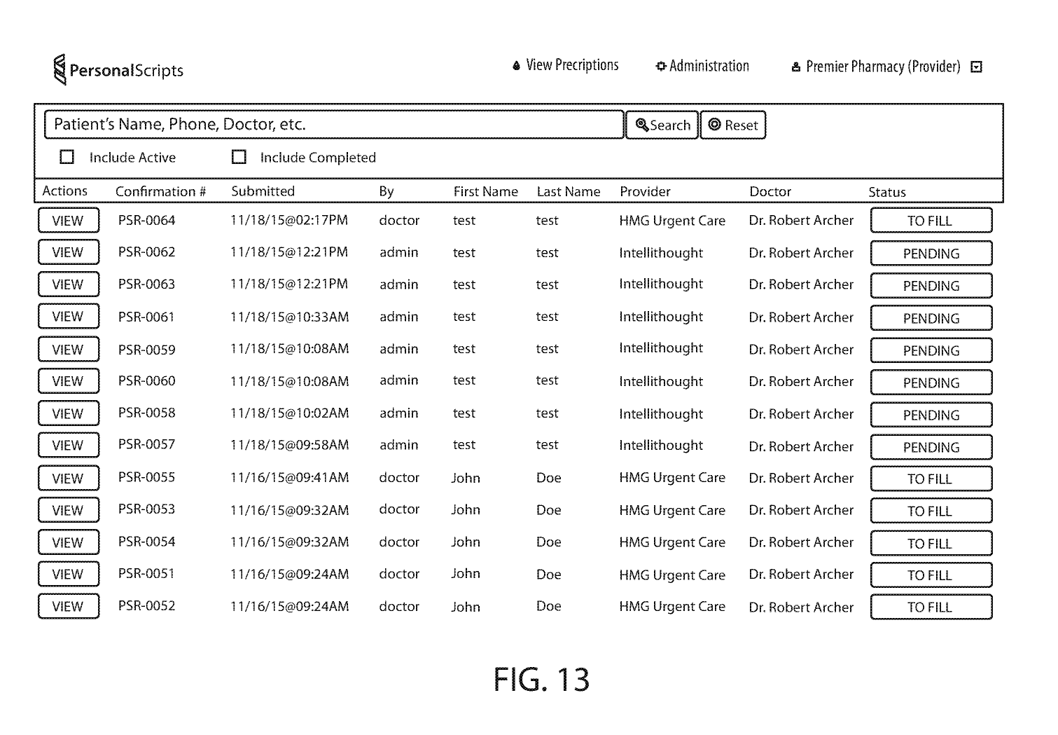

FIG. 13 shows an example of a dashboard screenshot for pending prescriptions that may be displayed on a pharmacy device 50a-50c. The dashboard includes all current and completed prescription submissions in a table format. This table is sortable by any column desired. Additionally, a search tool allows for quickly locating prescriptions in the system. One may click “view” to view a specific prescription. Once inside a prescription, the following options are available: (1) cancel—this cancels the process and moves the script out of the view of the Prescription Viewer (but does not delete the script from the database); (2) mark completed—this moves the script to the status of complete and out of the default view in the Prescription Viewer; and (3) print—this allows for printing of the script.

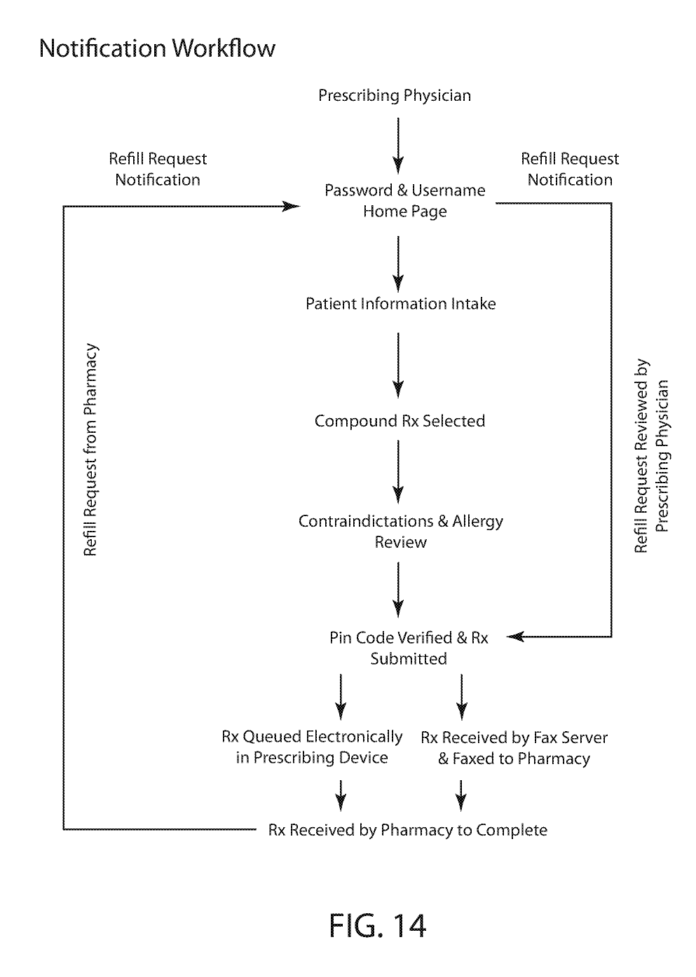

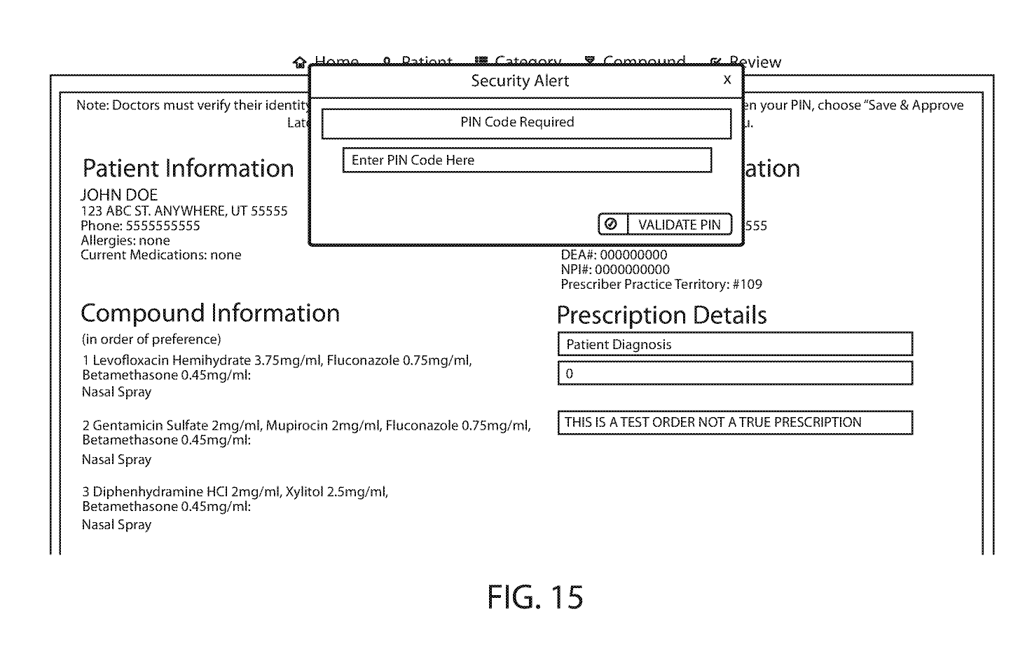

FIG. 14 illustrates the notification workflow using system 10. Here the user (who may be a prescribing physician or a pharmacist) logs into the system and selects to “Place Prescription for Patient.” The user then enters the patient and office information. Next the user selects the compound to be filled and reorders the compounds based on preference. The user may optionally create a custom compound with ingredients of the user's choosing. Then the user confirms the prescription and clicks “finish” (on the screen shown in FIG. 12). When finished, the prescribing physician is prompted to enter his or her PIN that the prescribing physician chooses when creating the account (the PIN may be reset by the prescribing physician if forgotten). An example of a screenshot prompting the prescribing physician for a PIN is shown in FIG. 15. The prescribing physician's electronic signature, which may be previously stored in the prescribing physician's profile, may then be automatically applied to the prescription order that is sent to the pharmacy. Once the script has been submitted, the next steps occur as follows: (1) if a pharmacy user, the script is sent to the prescribing physician's notifications screen for approval, or (2) if a prescribing physician user, the prescription order is faxed to the selected pharmacy and the prescribing physician can also print the script information. Note that when scripts are pending in the prescribing physician's notifications screen, the prescribing physician can approve them. This triggers the prescription order to be faxed (or otherwise submitted) to the selected pharmacy.

With concerns to patient's choice, the system may allow the patient to have their prescription order filled by the pharmacy of their choosing (i.e. utilize the pharmacy providing the electronic prescribing service by electronic submission or the prescription may be printed and submitted to an alternative pharmacy by fax transmission or other means).

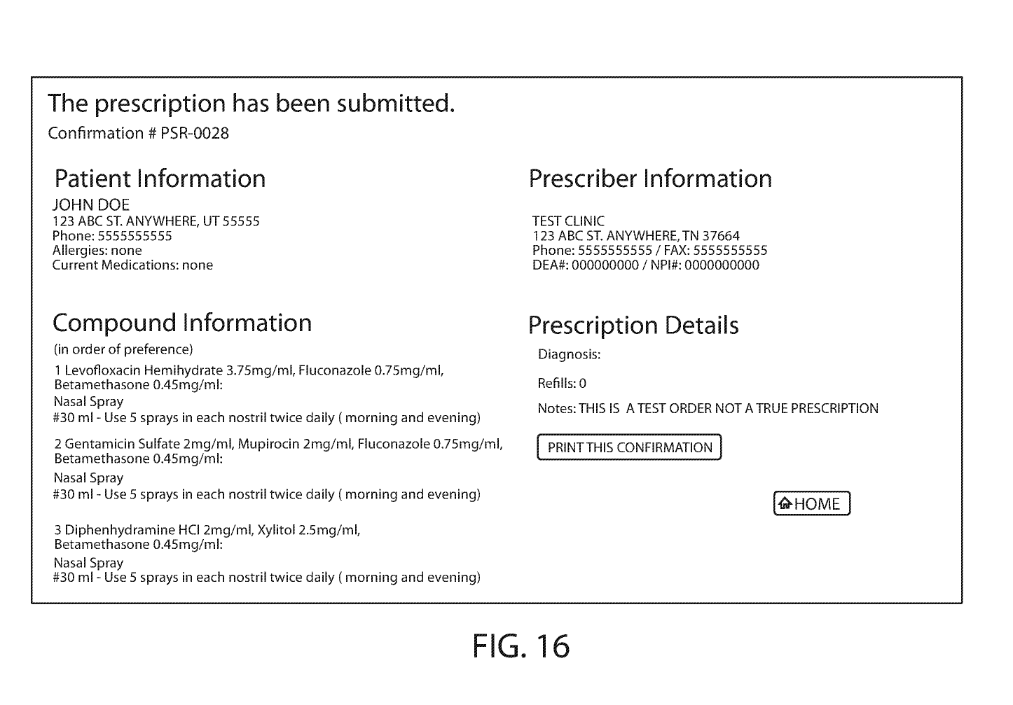

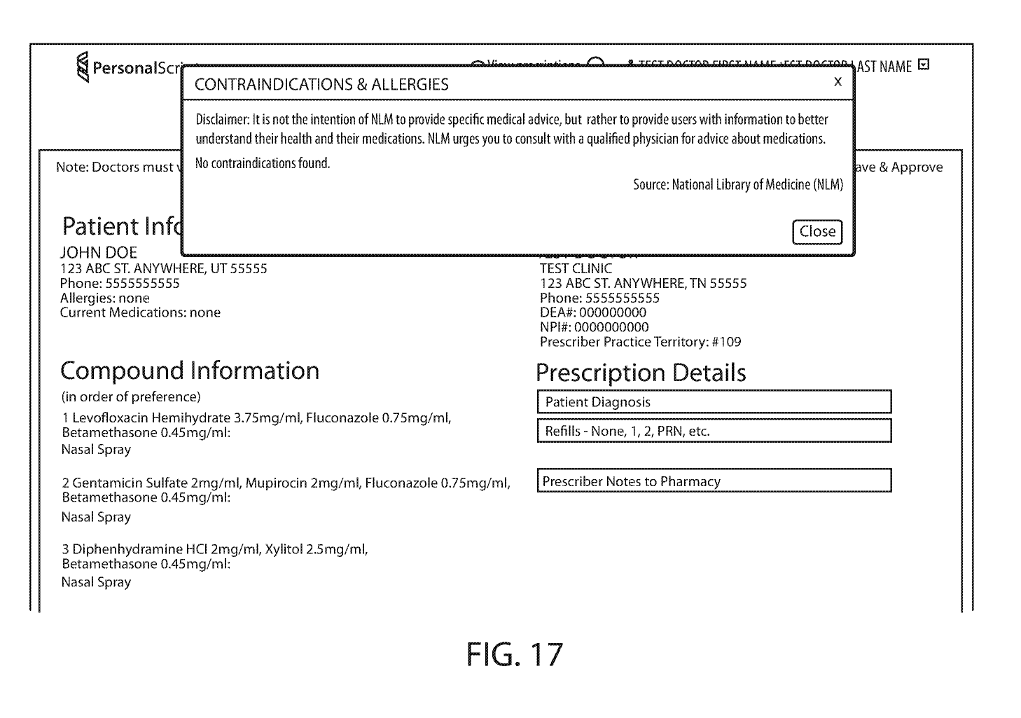

An example of a prescription order is shown in FIG. 16. The prescription order may include, but is not limited to; a unique identifier for the prescription order (confirmation#), the patient's information (name, date of birth (DOB), address, phone#, listed allergies, current list of medications), prescribing physician's information (name, address, telephone#, fax#, NPl#, DEA#, signature, name of practice site, unique prescribing physician ID#), intended pharmacy information, selected compounded medication(s), prescription details (diagnosis code, number of refills, and specific notes to the pharmacy), a time stamp and date when prescription was submitted and by whom, and a list of any potential contraindications. Alternatively, a popup notification of contraindications may appear as shown in FIG. 17.

The system and method thus provides to a Prescription Manager: the ability to add, activate/deactivate users (i.e. physicians); the ability to add, activate/deactivate drug classes; the ability to add, activate/deactivate specific active pharmaceutical ingredients; the ability to add, activate/deactivate drug categories; and the ability to add, activate/deactivate entire compound formulations. Further, it allows a Provider: the ability to prescribe preselected compounded formulations; the ability to create and prescribe compounded formulations; the ability to rearrange compounded formulations based on order of preference; the ability to check for drug to drug interactions, contraindications and drug allergies; and the ability to physically print the prescription order or submit electronically to the intended pharmacy.

Although the above description is focused on custom compounded medications, the system 10 may also be used for prescribing FDA approved medications as well.

The methods, devices, and systems described herein may be implemented in many different ways in many different combinations of hardware, software or both hardware and software. For example, all or parts of the system may include circuitry in a controller, a processor, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the claims as interpreted according to the principles of patent law, including the doctrine of equivalents.

What is claimed is:

1. A system for processing prescriptions of customized medications, comprising:
a memory storing a database of ingredients that may be used in custom compounded medications and drug interactions between the ingredients, wherein one of said database and an additional database includes patient information including identification of patients and their prescribed medications; and
a processor configured to interact with the database and further configured to:
receive a prescription request for a customized medication from a user for a selected patient;
retrieve any existing prescribed medications for the selected patient;
in response to the prescription request, prompt the user to select ingredients of the customized medication;
upon selection of all ingredients of the customized medication, access said database to compare each ingredient of the customized medication to any existing prescribed medications and their ingredients to identify any potential drug interactions; and
when any potential drug interactions are identified, create an alert to inform the user of any potential drug interactions resulting from prescribing the customized medication.

2. The system of claim 1, wherein the patient information further includes at least one of: the patient's address, the patient's phone number, and the patient's allergies to available ingredients.

3. The system of claim 1, wherein the database of ingredients further includes at least one of: known ingredients used in medications, known compounds and their ingredients, known drug interactions between ingredients, categories of compounds, and lists of compounds in each category along with active ingredients and dosages of ingredients.

4. The system of claim 1, and further comprising at least one pharmacy device each associated with a pharmacy, wherein the server processor is further configured to:
prompt a user to select a pharmacy for a patient, and
when no potential drug interactions are identified, forward the prescription request to the at least one pharmacy device associated with the selected pharmacy.

5. The system of claim 1, wherein the server processor is further configured to:
in response to the prescription request, prompt the user to select a category of the customized medication;
after selection of the category, cause to be displayed on a display of the user, medications/ingredients categorized in the selected category;
prompt the user to provide ingredients of the customized medication; and
upon selection of all ingredients of the customized medication, alert a pharmacist of the prescription request.

6. The system of claim 1 and further comprising a prescribing physician database that includes a profile for each registered prescribing physician, wherein each profile includes at least one of: the prescribing physician's name, office name, address, phone number, email, security role, username, password, electronic signature, provider, and a personal identification number.

7. A system for processing prescriptions of customized medications, comprising:
a prescription server device comprising:
a memory storing a database of ingredients that may be used in custom compounded medications and drug interactions between the ingredients, wherein one of said database and an additional database includes patient information including identification of patients and their prescribed medications, and a server processor configured to interact with the database; and
at least one prescriber device for interacting with said prescription server device over a distributed computer network and configured to generate a prescription request for a customized medication for a selected patient,
wherein said server processor is further configured to:
receive a prescription request for a customized medication from said at least one prescriber device for a selected patient;
retrieve any existing prescribed medications for the selected patient;
in response to the prescription request, prompt said at least one prescriber device to provide ingredients of the customized medication;
upon selection of all ingredients of the customized medication, access said database to compare each ingredient of the customized medication to any existing prescribed medications and their ingredients to identify any potential drug interactions; and
when any potential drug interactions are identified, create an alert to inform said at least one prescriber device of any potential drug interactions resulting from prescribing the customized medication.

8. The system of claim 7, wherein the patient information further includes at least one of: the patient's address, the patient's phone number, and the patient's allergies to available ingredients.

9. The system of claim 7, wherein the database of ingredients further includes at least one of: known ingredients used in medications, known compounds and their ingredients, known drug interactions between ingredients, categories of compounds, and lists of compounds in each category along with active ingredients and dosages of ingredients.

10. The system of claim 7, and further comprising at least one pharmacy device each associated with a pharmacy, wherein the server processor is further configured to:
prompt a user to select a pharmacy for a patient, and
when no potential drug interactions are identified, forward the prescription request to the at least one pharmacy device associated with the selected pharmacy.

11. The system of claim 7, wherein the server processor is further configured to:
in response to the prescription request, prompt the user to select a category of the customized medication;
after selection of the category, cause to be displayed on a display of the user, medications/ingredients categorized in the selected category;
prompt the user to provide ingredients of the customized medication; and
upon selection of all ingredients of the customized medication, alert a pharmacist of the prescription request.

12. The system of claim 7 and further comprising a pharmacy database including a listing of various pharmacies through which prescriptions may be filled.

13. The system of claim 7 and further comprising a prescribing physician database that includes a profile for each registered prescribing physician, wherein each profile includes at least one of: the prescribing physician's name, office name, address, phone number, email, security role, username, password, electronic signature, provider, and a personal identification number.

14. A method of processing prescriptions of customized medications where the prescriptions are received from devices over a computer distributed network, the method comprising:
storing in a memory device, a database of ingredients that may be used in custom compounded medications and drug interactions between the ingredients, wherein one of said database and an additional database includes patient information including identification of patients and their prescribed medications;
receiving a prescription request for a customized medication from a user for a selected patient;
retrieving any existing prescribed medications for the selected patient;
prompting the user to select ingredients of the customized medication;
upon selection of all ingredients of the customized medication, accessing the database to compare each ingredient of the customized medication to any existing prescribed medications and their ingredients to identify any potential drug interactions; and
when any potential drug interactions are identified, creating an alert to inform the user of any potential drug interactions resulting from prescribing the customized medication.

15. A non-transitory tangible computer readable medium having stored thereon software instructions that, when executed by a processor in a server, cause the processor to process a prescription request for a custom compounded medication, by executing the steps comprising:
storing in a memory device, a database of ingredients that may be used in custom compounded medications and drug interactions between the ingredients, wherein one of said database and an additional database includes patient information including identification of patients and their prescribed medications;
receiving a prescription request for a customized medication from a user for a selected patient;
retrieving any existing prescribed medications for the selected patient;
prompting the user to select ingredients of the customized medication;
upon selection of all ingredients of the customized medication, accessing the database to compare each ingredient of the customized medication to any existing prescribed medications and their ingredients to identify any potential drug interactions; and
when any potential drug interactions are identified, creating an alert to inform the user of any potential drug interactions resulting from prescribing the customized medication.

16. A system for processing prescriptions of customized medications, comprising:
a memory storing a database of ingredients that may be used in custom compounded medications, wherein one of said database and an additional database includes patient information including identification of patients and their prescribed medications; and
a processor configured to interact with the database and further configured to:
receive a prescription request for a customized medication from a user for a selected patient;
in response to the prescription request, prompt the user to select a category of the customized medication;
after selection of the category, cause to be displayed on a display of the user, medications/ingredients categorized in the selected category;
prompt the user to provide ingredients of the customized medication; and
upon selection of all ingredients of the customized medication, alert a pharmacist of the prescription request.

17. The system of claim 16, wherein said server processor is further configured to:
retrieve any existing prescribed medications for the selected patient;
upon selection of all ingredients of the customized medication, access said database to compare each ingredient of the customized medication to any existing prescribed medications and their ingredients to identify any potential drug interactions; and
when any potential drug interactions are identified, create an alert to inform of any potential drug interactions resulting from prescribing the customized medication.

18. The system of claim 17, and further comprising at least one pharmacy device each associated with a pharmacy, wherein the server processor is further configured to:
prompt a user to select a pharmacy for a patient, and
when no potential drug interactions are identified, alert the pharmacist of the prescription request by forwarding the prescription request to the at least one pharmacy device associated with the selected pharmacy.

19. The system of claim 16, wherein the patient information further includes at least one of:
the patient's address, the patient's phone number, and the patient's allergies to available ingredients.

20. The system of claim 16, wherein the database of ingredients further includes at least one of: known ingredients used in medications, known compounds and their ingredients, known drug interactions between ingredients, categories of compounds, and lists of compounds in each category along with active ingredients and dosages of ingredients.

21. The system of claim 16, wherein the server processor is further configured to:
in response to the prescription request, prompt the user to select a category of the customized medication;
after selection of the category, cause to be displayed on a display of the user, medications/ingredients categorized in the selected category;
prompt the user to provide ingredients of the customized medication; and
upon selection of all ingredients of the customized medication, alert a pharmacist of the prescription request.

22. The system of claim 16 and further comprising a prescribing physician database that includes a profile for each registered prescribing physician, wherein each profile includes at least one of: the prescribing physician's name, office name, address, phone number, email, security role, username, password, electronic signature, provider, and a personal identification number.
